(19) United States
(12) Patent Application Publication
(10) Pub. No.: US 2020/0218970 A1
(43) Pub. Date: Jul. 9, 2020

(54) Artificial Intelligence Devices For Keywords Detection

(71) Applicant: GYRFALCON TECHNOLOGY INC., Milpitas, CA (US)

(72) Inventors: Lin Yang, Milpitas, CA (US); Baohua Sun, Fremont, CA (US)

(21) Appl. No.: 16/299,104

(22) Filed: Mar. 11, 2019

Related U.S. Application Data
(60) Provisional application No. 62/789,447, filed on Jan. 7, 2019.

(51) Int. Cl. G06N 3/08; G06N 3/04; G06F 16/9032; G06F 16/9035; G06F 17/21; G06K 9/62

(52) U.S. Cl. CPC G06N 3/08; G06N 3/0418; G06K 9/6267; G06F 16/9035; G06F 17/214; G06F 16/90332

(57) ABSTRACT

A list of keywords in a category of interest is defined and a list of to-be-excluded items is derived therefrom. A first set of general texts is obtained. A second set of texts is created by inserting or replacing a randomly selected item from the list of keywords into each of the first set at a randomly chosen location. A third set of texts is created by inserting or replacing a randomly selected item from the list of to-be-excluded into each of the first set at a randomly chosen location. First and second groups of 2-D symbols are formed to graphically represent the second set and the third set, respectively. The first group is associated with the category of interest while the second group is associated with the category of uninterested. Keyword detection training dataset is created by combining first and second groups of 2-D symbols.

### CROSS-REFERENCE TO RELATED APPLICATIONS

This application claims benefits of a U.S. Provisional Patent Application Ser. No. 62/789,447 for “Artificial Intelligence Devices For Keywords Detection”, filed Jan. 7, 2019. The contents of which are hereby incorporated by reference in its entirety for all purposes.

### FIELD

This patent document relates generally to the field of machine learning. More particularly, the present document relates to artificial intelligence devices for keywords detection.

### BACKGROUND

Machine learning is an application of artificial intelligence. In machine learning, a computer or computing device is programmed to think like human beings so that the computer may be taught to learn on its own. The development of neural networks has been key to teaching computers to think and understand the world in the way human beings do.

In recent years of social media, keywords have been an important factor in online marketing for a number of years. Anyone with a website will be familiar with Search Engine Optimization (SEO), of which keywords play a large part. But keywords—the words and phrases people are using to search for something—are also a key part of social media. Selecting the correct keywords for a business is all about doing some groundwork, but as they are so crucial in a crowded market place, with everyone vying for people's attention, it will be time well spent. Therefore, there is a need to detect keywords efficiently and effectively from vast amount of data in today's digital environment.

### SUMMARY

This section is for the purpose of summarizing some aspects of the invention and to briefly introduce some preferred embodiments. Simplifications or omissions in this section as well as in the abstract and the title herein may be made to avoid obscuring the purpose of the section. Such simplifications or omissions are not intended to limit the scope of the invention.

Artificial intelligence devices for keywords detection and methods implemented in a computer system for enabling an artificial intelligence device for keywords detection are disclosed. According one aspect of the disclosure, a list of keywords in a category of interest is defined and received by a user in a computer system. A first set of general texts unrelated to the category of interest is obtained. Each sample or record of the first set is expanded to include all possible short samples. A second set of texts is created by inserting or replacing a randomly selected item from the list of keywords into each of the first set of texts at a randomly chosen location within each of the first set. A third set of texts is created by inserting or replacing a randomly selected item from the list of to-be-excluded into each of the first set of texts at a randomly chosen location within each of the first set. A first group of 2-D symbols are formed to graphically represent the second set while the second group of 2-D symbols are formed to graphically represent the third set. The first group is associated with the category of interest while the second group is associated with the category of uninterested. Keyword detection training dataset is created by combining first and second groups of 2-D symbols.

Filter coefficients of ordered convolutional layers in a deep learning model are trained using the keyword detection training dataset with an image classification technique. Trained filter coefficients are loaded into an artificial intelligence device for detecting one of the list of keywords in an input text string.

According to yet another aspect, an artificial intelligence device contains a bus, an input interface operatively connecting to the bus for receiving an input string of texts, a processing unit operatively connecting to the bus for forming a two-dimensional (2-D) symbol using a 2-D symbol creation application module installed thereon, the 2-D symbol being a matrix of N×N pixels of data for containing the input string of texts, and a Cellular Neural Networks or Cellular Nonlinear Networks (CNN) based integrated circuit loaded with a deep learning model for detecting whether the input string of texts contains one of the list of keywords, filter coefficients of a plurality of ordered convolutional layers in the deep learning model being trained using a keyword detection training dataset with an image classification technique. N is positive integer (e.g., 224).

Objects, features, and advantages of the invention will become apparent upon examining the following detailed description of an embodiment thereof, taken in conjunction with the attached drawings.

### BRIEF DESCRIPTION OF THE DRAWINGS

These and other features, aspects, and advantages of the invention will be better understood with regard to the following description, appended claims, and accompanying drawings as follows:

FIG. 1 is a diagram illustrating an example two-dimensional (2-D) symbol comprising a matrix of N×N pixels of data for containing graphical image of a string of texts according to an embodiment of the invention;

FIG. 2A is a diagram showing an example list of keywords for an example category of interest according to an embodiment of the invention;

FIG. 2B is a diagram showing an example expanded list of keywords in accordance with an embodiment of the invention;

FIG. 2C is a diagram showing an example list to-be-excluded items in accordance with an embodiment of the invention;

FIG. 2D is a diagram showing an example of a first set of general texts of various topics unrelated to the category of interest for creating a keyword detection training dataset in accordance with one embodiment of the invention;

FIG. 2E is a diagram showing an example scheme of expanding a record/sample of the first set of general texts to a plurality of shorter records/samples in accordance with an embodiment of the invention;

FIG. 3A is a diagram showing example 2-D symbols that contain the second set of texts which is modified with a randomly selected item from the expanded list of keywords to the first set of general texts according to an embodiment of the invention;

FIG. 3B is a diagram showing example 2-D symbols that contain the third set of texts which is modified with a randomly selected item from the list of to-be-excluded items to the first set of general texts according to an embodiment of the invention;

FIG. 3C is a diagram showing another example 2-D symbols that contain unmodified first set of general texts in accordance with an embodiment of the invention;

FIG. 4A is a block diagram illustrating an example Cellular Neural Networks or Cellular Nonlinear Networks (CNN) based computing system for classifying a two-dimensional symbol, according to one embodiment of the invention;

FIG. 4B is a block diagram illustrating an example CNN based integrated circuit for performing image processing based on convolutional neural networks, according to one embodiment of the invention;

FIGS. 5A-5C are collectively a flowchart illustrating an example process of enabling an artificial intelligence device for keyword detection in accordance with one embodiment of the invention;

FIG. 6 is a schematic diagram showing an example binary image classification of a multi-layer two-dimensional symbol in accordance with an embodiment of the invention;

FIG. 7 is a schematic diagram showing an example image processing technique based on convolutional neural networks in accordance with an embodiment of the invention;

FIG. 8 is a diagram showing an example CNN processing engine in a CNN based integrated circuit, according to one embodiment of the invention;

FIG. 9 is a diagram showing an example imagery data region within the example CNN processing engine of FIG. 8, according to an embodiment of the invention;

FIGS. 10A-10C are diagrams showing three example pixel locations within the example imagery data region of FIG. 9, according to an embodiment of the invention;

FIG. 11 is a diagram illustrating an example data arrangement for performing 3×3 convolutions at a pixel location in the example CNN processing engine of FIG. 8, according to one embodiment of the invention;

FIGS. 12A-12B are diagrams showing two example 2×2 pooling operations according to an embodiment of the invention;

FIG. 13 is a diagram illustrating a 2×2 pooling operation of an imagery data in the example CNN processing engine of FIG. 8, according to one embodiment of the invention;

FIGS. 14A-14C are diagrams illustrating various examples of imagery data region within an input image, according to one embodiment of the invention;

FIG. 15 is a diagram showing a plurality of CNN processing engines connected as a loop via an example clock-skew circuit in accordance of an embodiment of the invention;

FIG. 16 is a function diagram showing a first example artificial intelligence device for keywords detection in accordance with one embodiment of the invention; and

FIG. 17 is a function diagram showing a second example artificial intelligence device for keywords detection in accordance with one embodiment of the invention.

### DETAILED DESCRIPTIONS

In the following description, numerous specific details are set forth in order to provide a thorough understanding of the invention. However, it will become obvious to those skilled in the art that the invention may be practiced without these specific details. The descriptions and representations herein are the common means used by those experienced or skilled in the art to most effectively convey the substance of their work to others skilled in the art. In other instances, well-known methods, procedures, and components have not been described in detail to avoid unnecessarily obscuring aspects of the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Used herein, the terms “vertical”, “horizontal”, “diagonal”, “left”, “right”, “top”, “bottom”, “column”, “row”, “diagonally” are intended to provide relative positions for the purposes of description, and are not intended to designate an absolute frame of reference. Additionally, used herein, term “character” and “script” are used interchangeably.

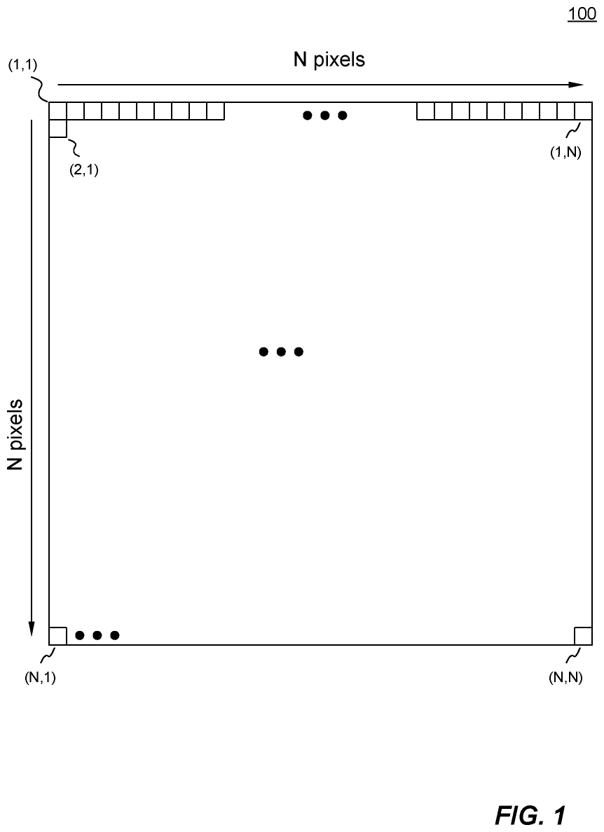

Embodiments of the invention are discussed herein with reference to FIGS. 1-17. However, those skilled in the art will readily appreciate that the detailed description given herein with respect to these figures is for explanatory purposes as the invention extends beyond these limited embodiments.

Referring first to FIG. 1, it is shown a diagram showing an example two-dimensional (2-D) symbol 100 for containing graphical image of a string of texts. The two-dimensional symbol 100 comprises a matrix of N×N pixels (i.e., N columns by N rows) of data. Pixels are ordered with row first and column second as follows: (1,1), (1,2), (1,3), . . . (1,N), (2,1), . . . , (N,1), (N,N). N is a positive integer, for example in one embodiment, N is equal to 224.

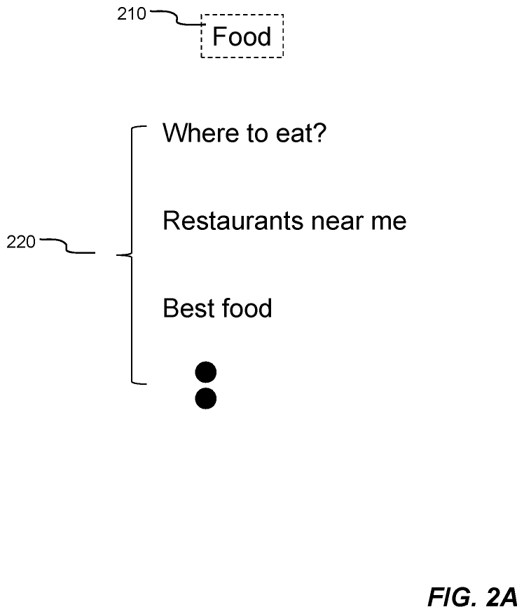

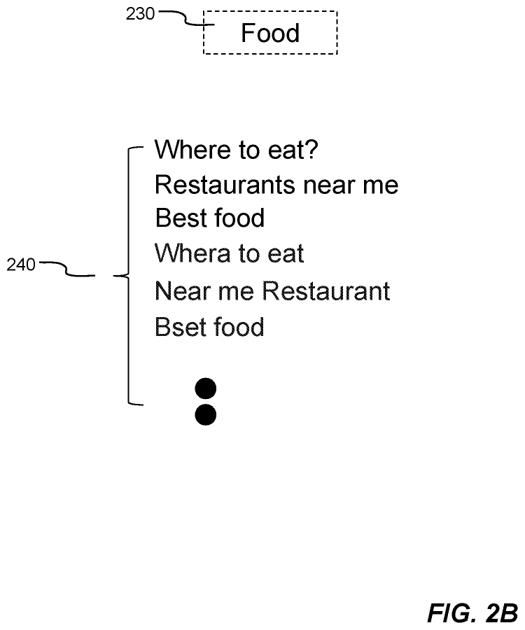

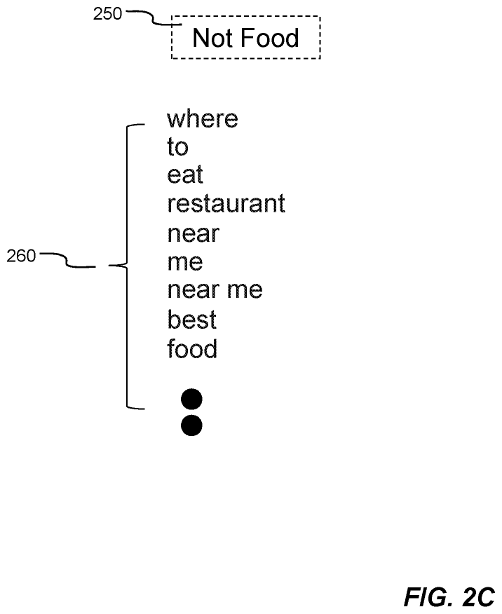

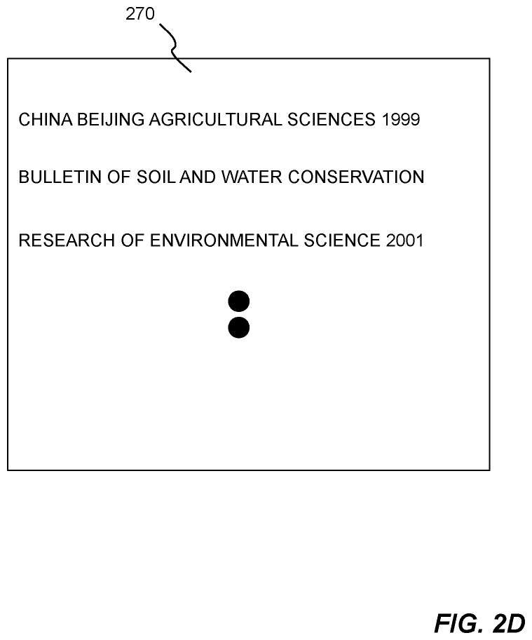

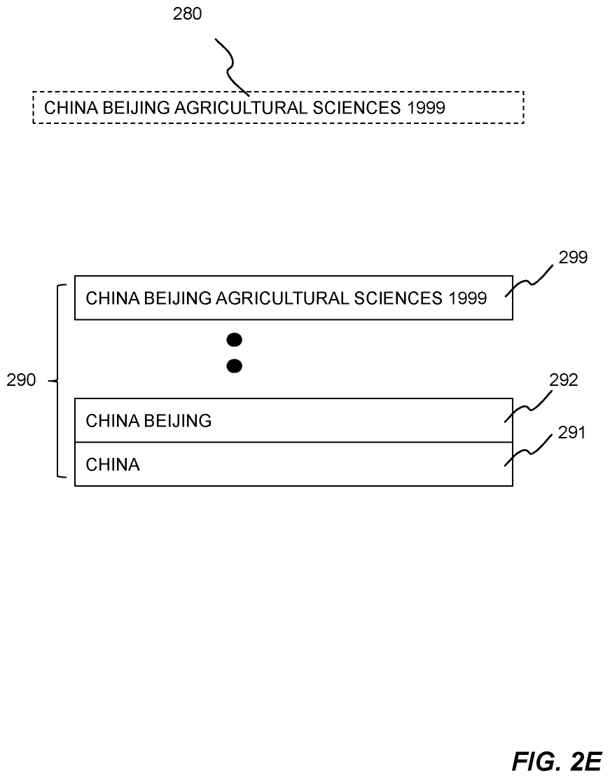

FIG. 2A is a diagram showing an example list of keywords 220 of a category of interest 210. In this example, the category of interest is “Food” 210 with a corresponding list of keywords 220: “Where to eat?”, “Restaurants near me”, “Best food”. The list of keywords can contain more or less than three keywords as shown. There is no limitation as to how many keywords in the list.

FIG. 2B is a diagram showing an example expanded list of keywords 240 of a category of interest 230. The expanded list of keywords 240 is created by modifying the list of keywords 220 to include additional words/phrases/sentences that can increase robustness in training of a deep learning model for keywords detection. In one embodiment, misspelled words are included as additional keywords. In another embodiment, a phrase with out-of-order words is included. For example, “Where to eat” may be expanded to include “Whera to eat?”, “Restaurants near me” may be expanded to “near me Restaurant”, “Best food” may be expanded to “Bset food”. In one embodiment, the expanded list of keywords can be generated using an algorithm (i.e., a software program). In another embodiment, the expanded list of keywords may be created by a user.

FIG. 2C is a diagram showing an example list of to-be-excluded or unwanted items 260 that contains words/phrases/sentences to be excluded. In one embodiment, to-be-excluded items include individual words of phrases or sentences in the list of keywords 220 of FIG. 2A. For example, words “Where”, “to”, “eat”, “restaurant”, “near”, “me”, “best”, “food” are the individual words of the keywords 220. In another embodiment, a shorter phrase may be excluded, for example, “near me” for “restaurant near me”. The list of to-be-excluded items 260 are used for avoiding false alarms or confusions during training of a deep learning model for keywords detection.

FIG. 2D shows an example first set of general texts of various topics 270 unrelated to the category of interest for creating a keyword detection training dataset. The first set of general texts 270 may be obtained or gathered from publicly available source or sources. One of the requirements is that the first set of texts do not contain any item in the expanded list of keywords. In this example, various titles of research articles are shown. Each of the original set contains a number of natural language words. In one embodiment, the natural language words are in one particular natural language. In another embodiment, the natural language words contain more than one natural languages (e.g., English and Chinese). In one embodiment, the first set of general texts 270 contains at least one million records or samples. Each sample contains L words of texts. L is a positive integer.

FIG. 2E shows an example scheme of expanding a record or sample of the first set of general texts to a plurality of shorter records or samples. An example sample text of L words 280 of the first set of general texts is expanded to L number of shorter samples 290. L is a positive integer and may not be the same for each of the samples. In other words, L varies from sample to sample. As it is demonstrated, the first word of 280 is the first shorter sample 291, the first two words of 280 is the second shorter sample 292, etc. In other words, the first word 280 that is not included in the last short sample is added to create the next short sample. The process is continued until the last short sample 299 is the sample text of length L 280.

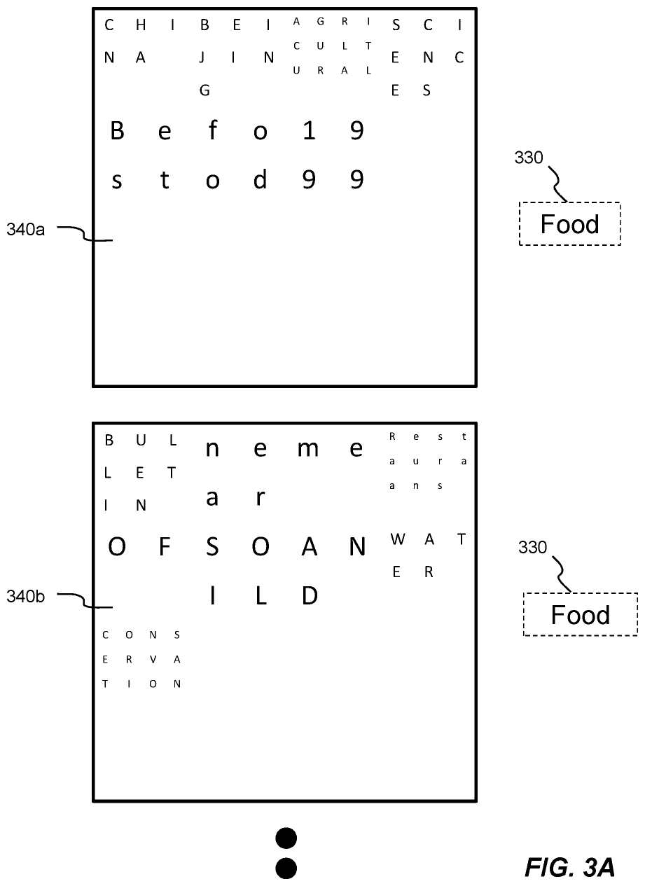

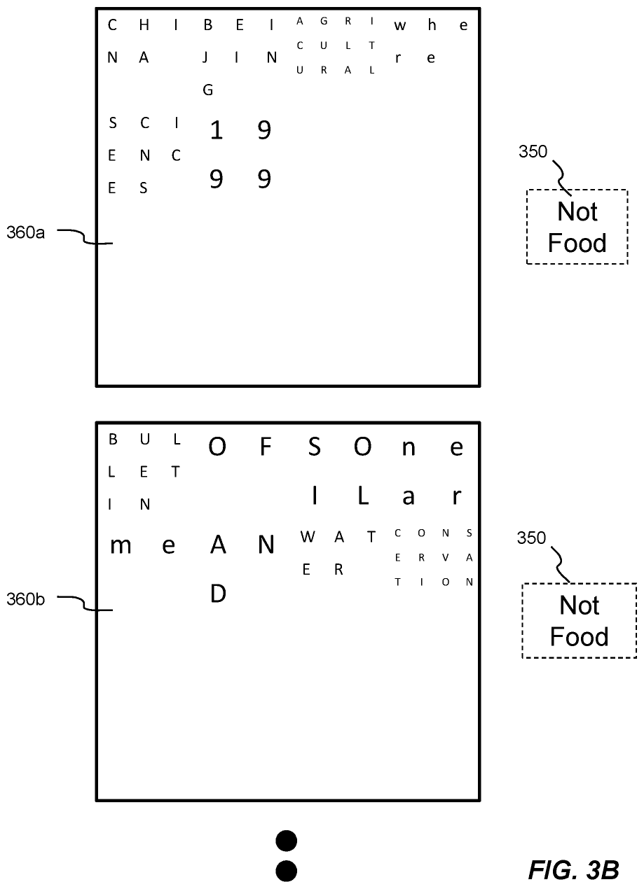

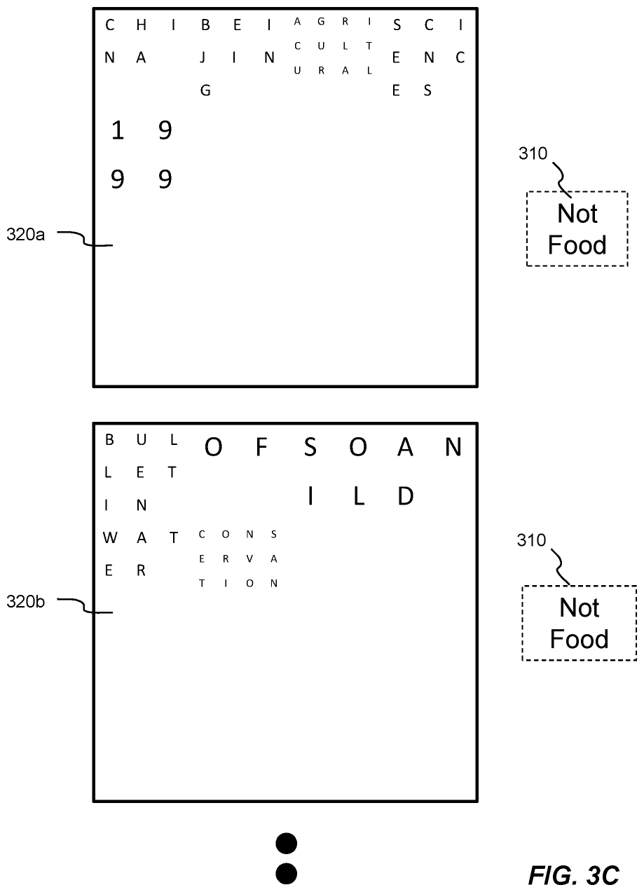

FIG. 3A shows example 2-D symbols 340a-340b that contain modified texts from the first set. The modification is carried out by inserting a randomly selected item from the expanded list of keywords or keywords at a randomly chosen location within each of the first set. Each of the 2-D symbols 340a-340b is a graphical image (i.e., an ideogram) representing corresponding sample of texts. And each sample is associated with a category of interest, which is “Food” 330 in this example. The graphical image in each 2-D symbol 340a-340b contains all words up to maximum number of words in each sample in a so-called “squared word” format. In the squared word format, each Latin-alphabet based word is converted to a square format based on the number of alphabets. For example, square format contains maximum of 1×1, 2×2, 3×3, 4×4, . . . words.

In 2-D symbol 340a, keyword “Best food” is inserted after the word “sciences”. In 2-D symbol 340b, keyword “near me Restaurant” is inserted after the word “Bulletin”. Although insertion is shown to demonstrate the modification, randomly selected keyword can replace the existing word or words to achieve the same. The goal is to modify the first set of general texts with one item from the list keywords. Each of the 2-D symbols 340a-340b is included in the keyword detection training dataset.

FIG. 3B shows example 2-D symbols 360a-360b that contain modified texts from the first set. The modification is carried out by inserting a randomly selected item from the list of to-be-excluded items at a randomly chosen location within each of the first set. Each of the 2-D symbols 360a-360b is associated with a category of uninterested or not interested, which is “Not Food” 350 in this example. In 2-D symbol 360a, a to-be-excluded item “where” is inserted after the word “AGRICULTURAL”. In 2-D symbol 360b, a to-be-excluded item “near me” is inserted between the word “SOIL” and the word “AND”. Although insertion is shown to demonstrate the modification, randomly selected to-be-excluded item can replace the existing word or words to achieve the same. The goal is to modify the first set of general texts with one of the to-be-excluded items. Each of the 2-D symbols 360a-360b is included in the keyword detection training dataset.

When the list of to-be-excluded items contains nothing, the third set of texts is the same as the first set of general texts because there is no item to be inserted/replaced. FIG. 3C shows such an example. 2-D symbols 320a-320b contain unmodified first set with each associated with a category of uninterested (i.e. “Not Food” 310). For illustration simplicity and clarity, the 2-D symbols shown in FIGS. 3A-3C contains 4×4 words, other sizes may be used for achieving the same(e.g., 64, 256, etc.).

With two categories set up in the keyword detection training dataset, a binary classification technique based on the two sets of 2-D symbols is used for training a deep learning model for keywords detection.

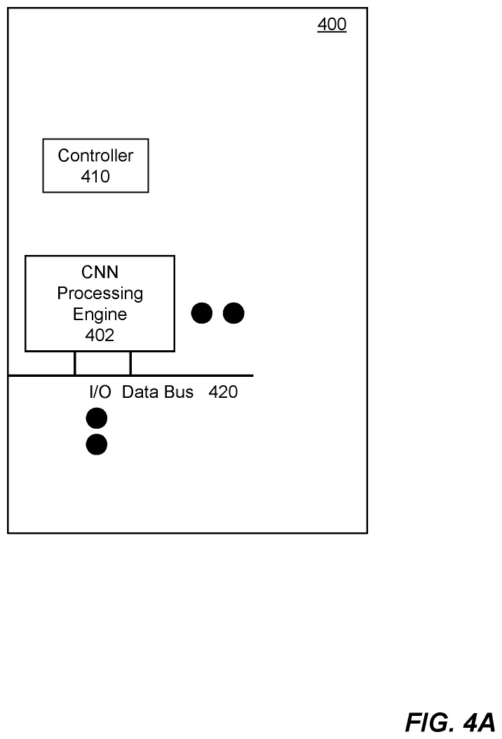

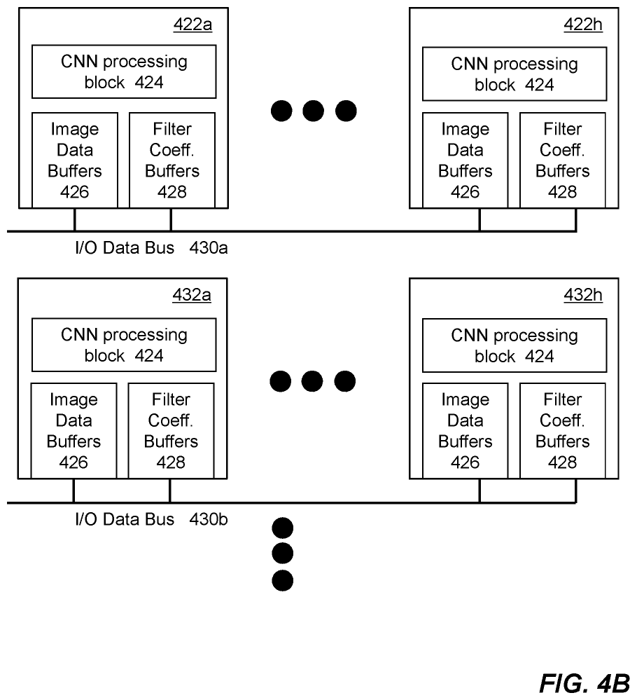

Referring now to FIG. 4A, it is shown a block diagram illustrating an example CNN based computing system 400 configured for classifying a two-dimensional symbol.

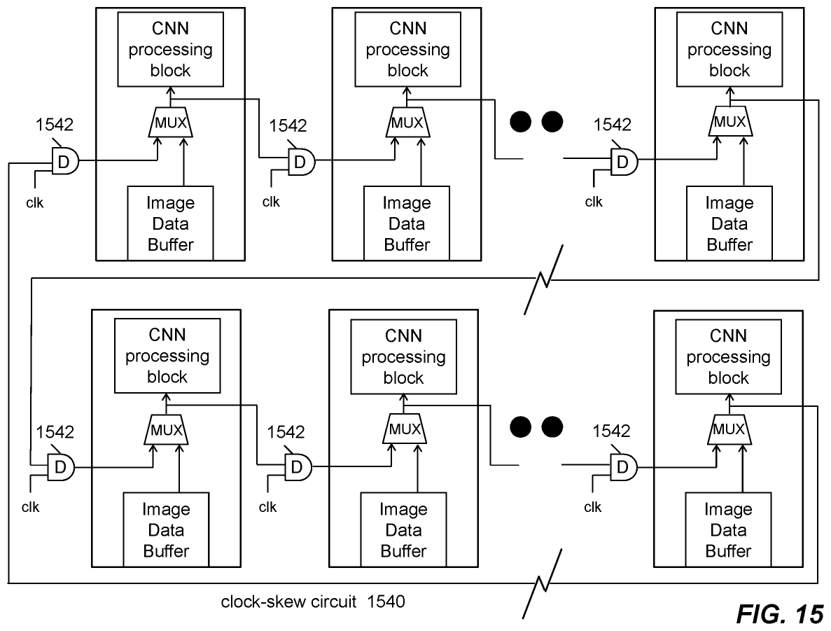

The CNN based computing system 400 may be implemented on integrated circuits as a digital semi-conductor chip (e.g., a silicon substrate in a single semi-conductor wafer) and contains a controller 410, and a plurality of CNN processing units 402a-402b operatively coupled to at least one input/output (I/O) data bus 420. Controller 410 is configured to control various operations of the CNN processing units 402a-402b, which are connected in a loop with a clock-skew circuit (e.g., clock-skew circuit 1540 in FIG. 15).

In one embodiment, each of the CNN processing units 402a-402b is configured for processing imagery data, for example, two-dimensional symbol 100 of FIG. 1.

In another embodiment, the CNN based computing system is a digital integrated circuit that can be extendable and scalable. For example, multiple copies of the digital integrated circuit may be implemented on a single semi-conductor chip as shown in FIG. 4B. In one embodiment, the single semi-conductor chip is manufactured in a single semi-conductor wafer.

All of the CNN processing engines are identical. For illustration simplicity, only few (i.e., CNN processing engines 422a-422h, 432a-432h) are shown in FIG. 4B. The invention sets no limit to the number of CNN processing engines on a digital semi-conductor chip.

Each CNN processing engine 422a-422h, 432a-432h contains a CNN processing block 424, a first set of memory buffers 426 and a second set of memory buffers 428. The first set of memory buffers 426 is configured for receiving imagery data and for supplying the already received imagery data to the CNN processing block 424. The second set of memory buffers 428 is configured for storing filter coefficients and for supplying the already received filter coefficients to the CNN processing block 424. In general, the number of CNN processing engines on a chip is 2ⁿ, where n is an integer (i.e., 0, 1, 2, 3, . . . ). As shown in FIG. 4B, CNN processing engines 422a-422h are operatively coupled to a first input/output data bus 430a while CNN processing engines 432a-432h are operatively coupled to a second input/output data bus 430b. Each input/output data bus 430a-430b is configured for independently transmitting data (i.e., imagery data and filter coefficients). In one embodiment, the first and the second sets of memory buffers comprise random access memory (RAM), which can be a combination of one or more types, for example, Magnetic Random Access Memory, Static Random Access Memory, etc. Each of the first and the second sets are logically defined. In other words, respective sizes of the first and the second sets can be reconfigured to accommodate respective amounts of imagery data and filter coefficients.

The first and the second I/O data bus 430a-430b are shown here to connect the CNN processing engines 422a-422h, 432a-432h in a sequential scheme. In another embodiment, the at least one I/O data bus may have different connection scheme to the CNN processing engines to accomplish the same purpose of parallel data input and output for improving performance.

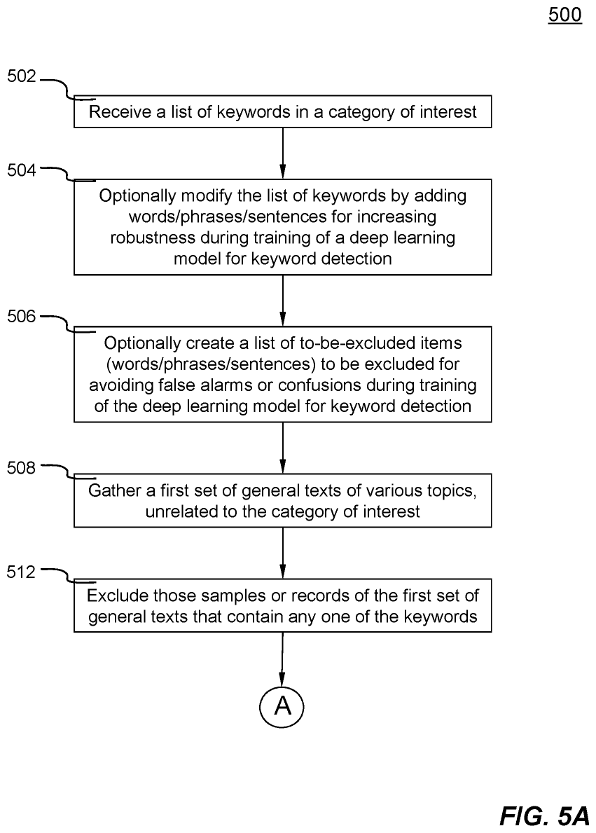

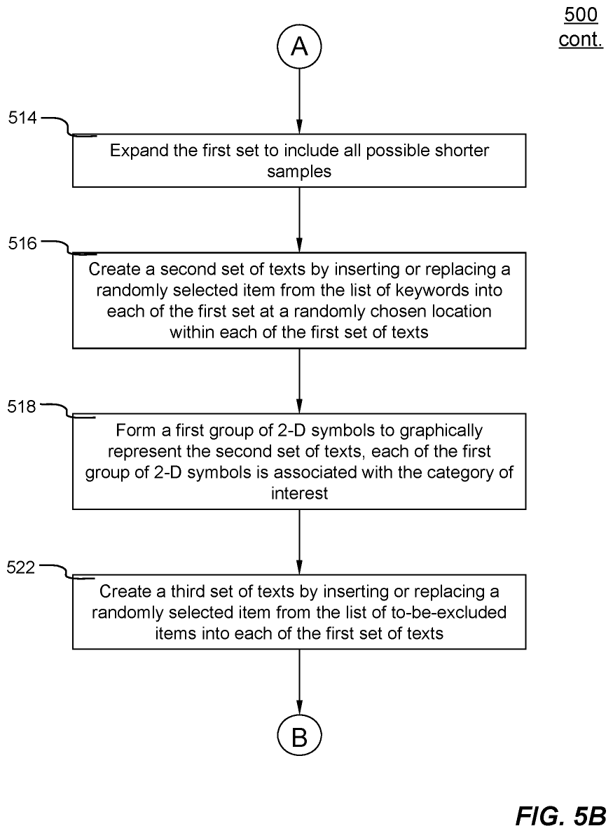

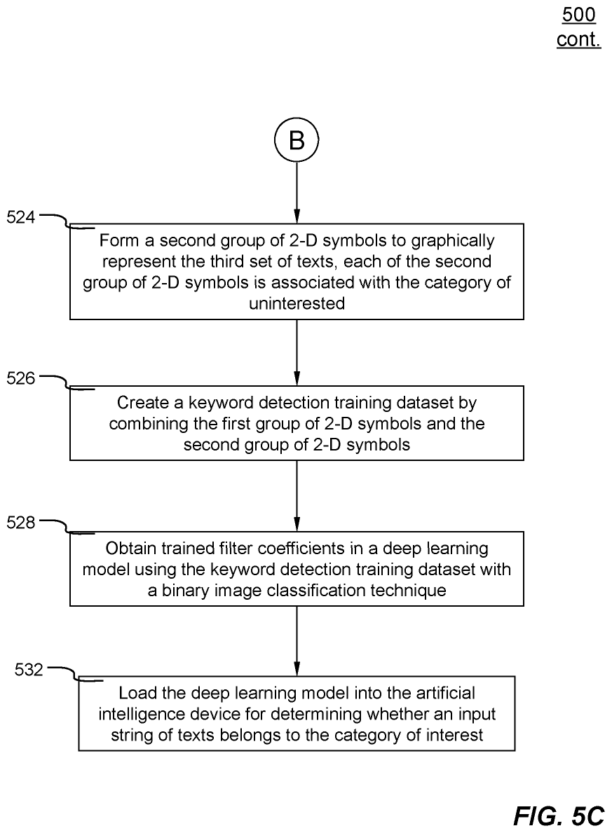

Referring now to FIGS. 5A-5C, there are collectively shown a flowchart illustrating an example computer-implemented process 500 of enabling an artificial intelligence device for keywords detection. Process 500 starts by defining and receiving a list of keywords (e.g., the list of keywords 220) in a category of interest (e.g., category “Food” 210) by a user of the artificial intelligence device for keywords detection at action 502. At action 504, the list of keywords is optionally modified for including, for examples, misspelled words, order of words rearranged or any user-defined terms for increasing robustness during training of a deep learning model for keywords detection. FIG. 2B shows an example of an expanded list of keywords 240. At action 506 a list of to-be-excluded items can be optionally created to include words/phrases/sentences to be excluded for avoiding false alarms or confusions during training of a deep learning model for keywords detection. FIG. 2C shows an example of to-be-excluded items 260. Next at action 508, a first set of general texts of various topics unrelated to the category of interest are obtained or gathered from any publicly available source or sources. The first set of texts contains a large number of samples or records, for example, 1,000,000 or more. If the first set contains too small number of samples or records, the first set may be duplicated as many times to contain large enough number of records or samples. The first set of general texts are used for creating a keyword detection training dataset. At action 512, those samples of the first set of general texts that contain any one of the keywords are excluded from the first set of texts.

Next in action 514, a first set of texts is expanded to include all possible shorter samples. When each sample of the first set of general texts contains L number of words, the sample becomes L samples. L is a positive integer and varies from sample to sample. FIG. 2E shows an example scheme of creating such shorter samples. Next in action 516, a second set of texts is created by inserting or replacing a randomly selected items from the expanded list of keywords into each of the first set of texts at a randomly selected location. At action 518, a first group of corresponding 2-D symbols is formed to graphically represent each of the second set of text. The category of interest (e.g., “Food”) is associated with each of the first group of 2-D symbols. In one embodiment, each 2-D symbol contains 64 words. For those samples of the first set of texts containing more than 64 words (i.e., L is greater than 64), they are cut off such that L equals 64. For those containing less than 64 words (i.e., L is less than 64), they are padded up such that L equals to 64. Next at action 522, a third set of texts is created by inserting or replacing a randomly selected items from the list of to-be-excluded items into each of the first set of texts at a randomly selected location.

At action 524, a second group of 2-D symbols is formed to graphically represent each of the third set of texts. Each of the second group of 2-D symbols is associated with the category of uninterested (e.g., “Not Food”). Next at action 526, the first group of corresponding 2-D symbols of the second set of the texts and the second group of corresponding 2-D symbols of the third set of the texts are combined to create a keyword detection training dataset.

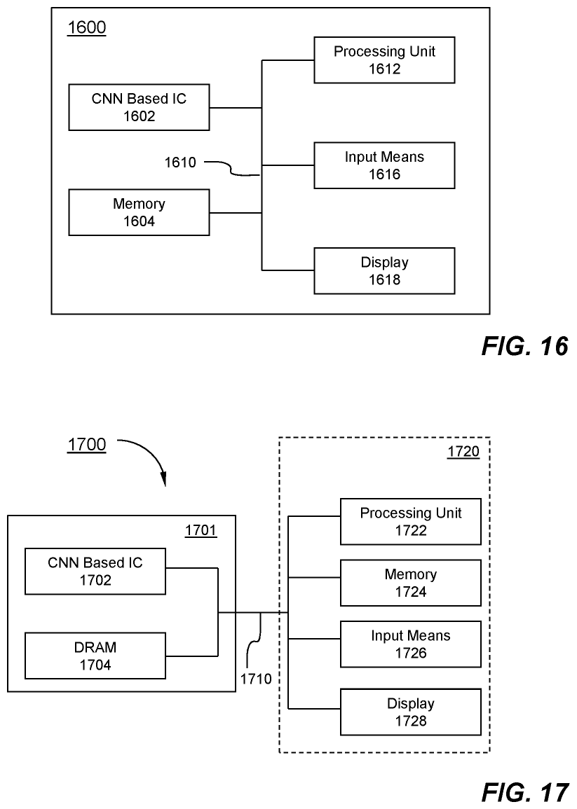

Then, at action 528, filter coefficients in a deep learning model are trained using the keyword detection training dataset with an image classification technique (e.g., binary classification). Finally, at action 532, the deep learning model in form of trained filter coefficients is loaded into the artificial intelligence device for detecting one of the listed keywords in an input string of texts. Two example artificial intelligence devices are shown in FIGS. 16-17.

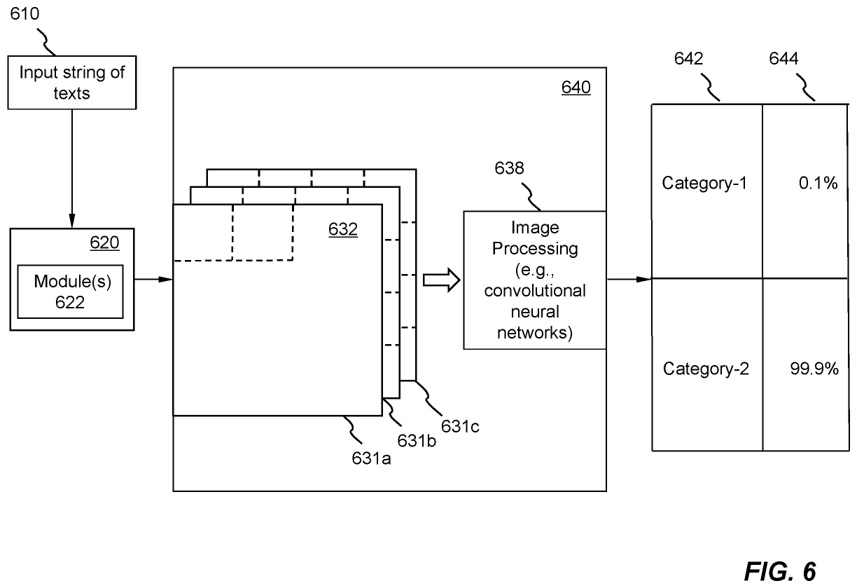

FIG. 6 is a schematic diagram showing an example binary image classification of a multi-layer two-dimensional symbol that contain graphical image of an input string of text 610.

Input string of texts 610 is received in a first computer system 620 and converted to a graphical image in a multi-layer 2-D symbol 632 with the 2-D symbol creation application module 622. Each two-dimensional symbol 631a-631c is a matrix of N×N pixels of data (e.g., three different color, Red, Green, and Blue).

The multi-layer two-dimensional symbol 631a-631c is classified in a second computing system 640 by using an image processing technique 638.

Transmitting the multi-layer 2-D symbol 631a-631c can be performed with many well-known manners, for example, through a network either wired or wireless.

In one embodiment, the first computing system 620 and the second computing system 640 are the same computing system (not shown).

In yet another embodiment, the first computing system 620 is a general-purpose computing system while the second computing system 640 is a CNN based computing system 400 implemented as integrated circuits on a semi-conductor chip shown in FIG. 4A.

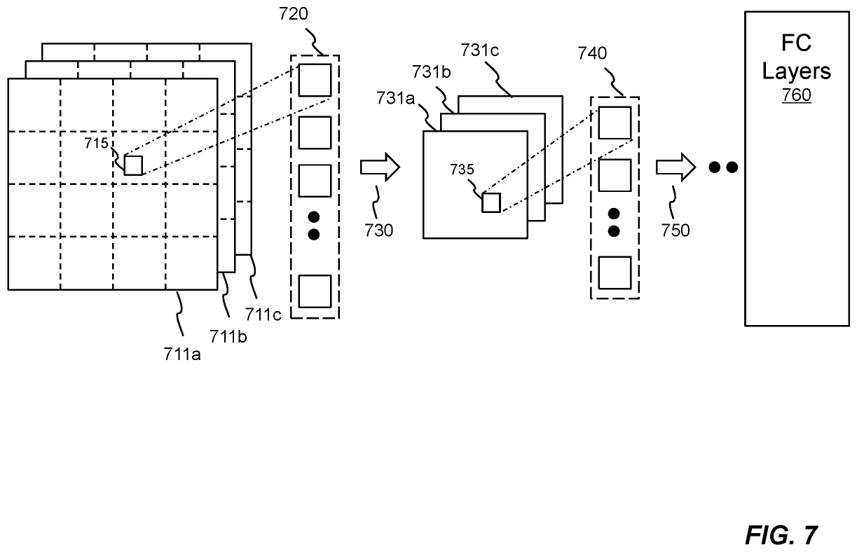

The image processing technique 638 includes predefining a set of categories 642 such as “Category-1” and “Category-2” for a binary image classification system shown in FIG. 6. As a result of performing the image processing technique 638, respective probabilities 644 of the categories are determined for associating each of the predefined categories 642 with the meaning of the super-character. In the example shown in FIG. 6, a highest probability of 99.9 percent is shown for “Category-2”. In other words, the multi-layer two-dimensional symbol 631a-631c contains a super-character whose meaning has a probability of 99.9 percent associated with “Category-2” amongst all the predefined categories 644. In one embodiment, the binary image classification technique 638 comprises example convolutional neural networks shown in FIG. 7.

FIG. 7 is a schematic diagram showing an example image processing technique based on convolutional neural networks in accordance with an embodiment of the invention.

Based on convolutional neural networks, a multi-layer two-dimensional symbol 711a-711c as input imagery data is processed with convolutions using a first set of filters or weights 720. Since the imagery data of the 2-D symbol 711a-711c is larger than the filters 720. Each corresponding overlapped sub-region 715 of the imagery data is processed. After the convolutional results are obtained, activation may be conducted before a first pooling operation 730. In one embodiment, activation is achieved with rectification performed in a rectified linear unit (ReLU). As a result of the first pooling operation 730, the imagery data is reduced to a reduced set of imagery data 731a-731c. For 2×2 pooling, the reduced set of imagery data is reduced by a factor of 4 from the previous set.

The previous convolution-to-pooling procedure is repeated. The reduced set of imagery data 731a-731c is then processed with convolutions using a second set of filters 740. Similarly, each overlapped sub-region 735 is processed. Another activation can be conducted before a second pooling operation 740. The convolution-to-pooling procedures are repeated for several layers and finally connected to a Fully-connected (FC) Layers 760. In image classification, respective probabilities 644 of predefined categories 642 can be computed in FC Layers 760.

This repeated convolution-to-pooling procedure is trained using a known dataset or database. For image classification, the dataset contains the predefined categories. A particular set of filters, activation and pooling can be tuned and obtained before use for classifying an imagery data, for example, a specific combination of filter types, number of filters, order of filters, pooling types, and/or when to perform activation. In one embodiment, the imagery data is the multi-layer two-dimensional symbol 711a-711c, which is form from a string of Latin-alphabet based language texts.

In one embodiment, convolutional neural networks are based on a Visual Geometry Group (VGG16) architecture neural nets.

More details of a CNN processing engine 802 in a CNN based integrated circuit are shown in FIG. 8. A CNN processing block 804 contains digital circuitry that simultaneously obtains Z×Z convolution operations results by performing 3×3 convolutions at Z×Z pixel locations using imagery data of a (Z+2)-pixel by (Z+2)-pixel region and corresponding filter coefficients from the respective memory buffers. The (Z+2)-pixel by (Z+2)-pixel region is formed with the Z×Z pixel locations as an Z-pixel by Z-pixel central portion plus a one-pixel border surrounding the central portion. Z is a positive integer. In one embodiment, Z equals to 14 and therefore, (Z+2) equals to 16, Z×Z equals to 14×14=196, and Z/2 equals 7.

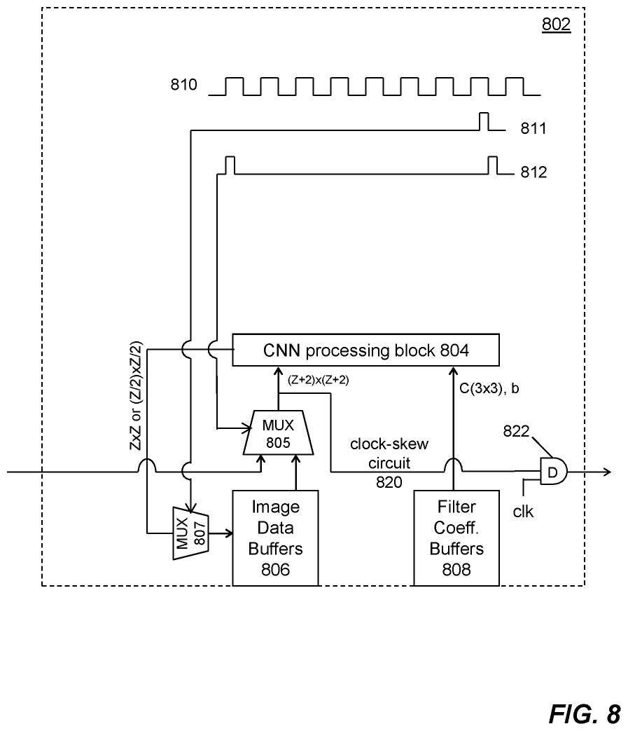

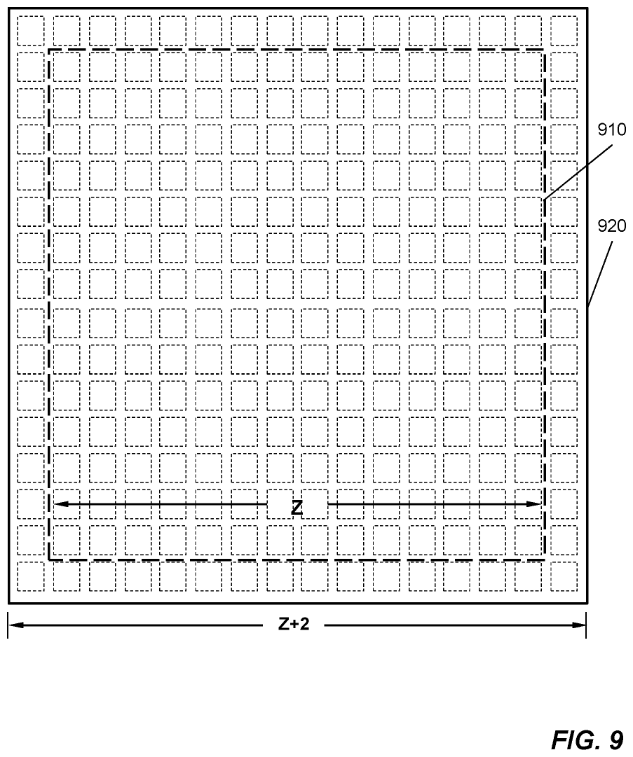

FIG. 9 is a diagram showing a diagram representing (Z+2)-pixel by (Z+2)-pixel region 910 with a central portion of Z×Z pixel locations 920 used in the CNN processing engine 802.

In order to achieve faster computations, few computational performance improvement techniques have been used and implemented in the CNN processing block 804. In one embodiment, representation of imagery data uses as few bits as practical (e.g., 5-bit representation). In another embodiment, each filter coefficient is represented as an integer with a radix point. Similarly, the integer representing the filter coefficient uses as few bits as practical (e.g., 12-bit representation). As a result, 3×3 convolutions can then be performed using fixed-point arithmetic for faster computations.

Each 3×3 convolution produces one convolution operations result, Out(m, n), based on the following formula:

$$Out ( m , n ) = {\sum }_{1 \leq i , j \leq 3} In ( m , n , i , j ) \times C ( i , j ) - b \qquad ( 1 )$$

where:
m, n are corresponding row and column numbers for identifying which imagery data (pixel) within the (Z+2)-pixel by (Z+2)-pixel region the convolution is performed;
In(m,n,i,j) is a 3-pixel by 3-pixel area centered at pixel location (m, n) within the region;

C(i, j) represents one of the nine weight coefficients C(3×3), each corresponds to one of the 3-pixel by 3-pixel area;
b represents an offset coefficient; and
i, j are indices of weight coefficients C(i, j).

Each CNN processing block 804 produces Z×Z convolution operations results simultaneously and, all CNN processing engines perform simultaneous operations. In one embodiment, the 3×3 weight or filter coefficients are each 12-bit while the offset or bias coefficient is 16-bit or 18-bit.

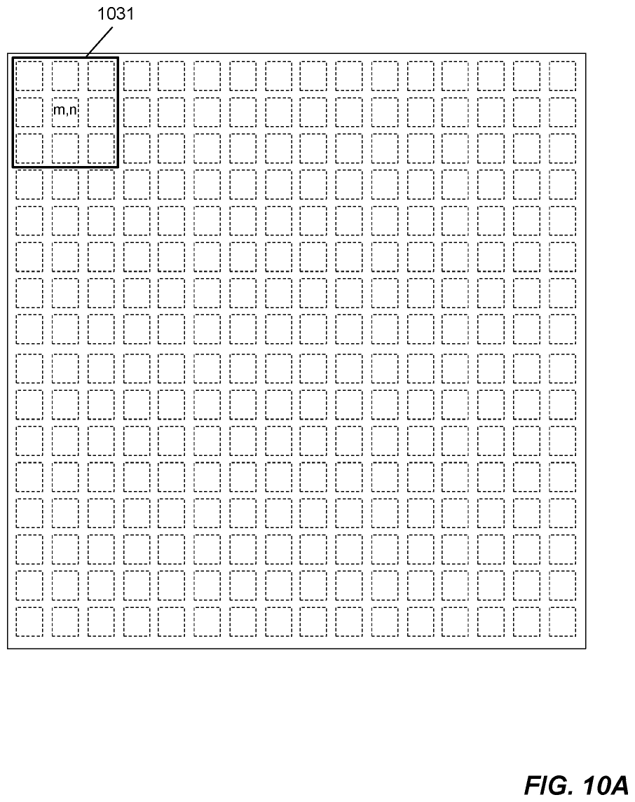

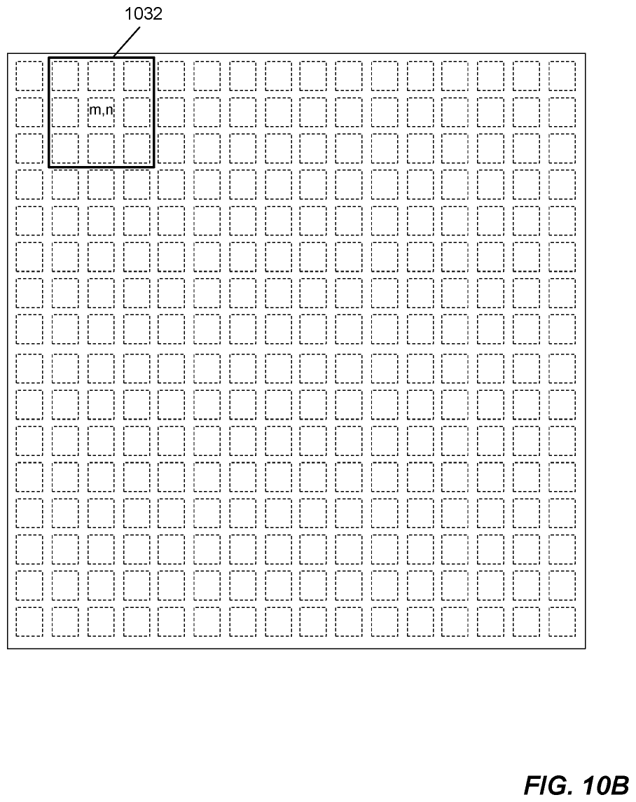

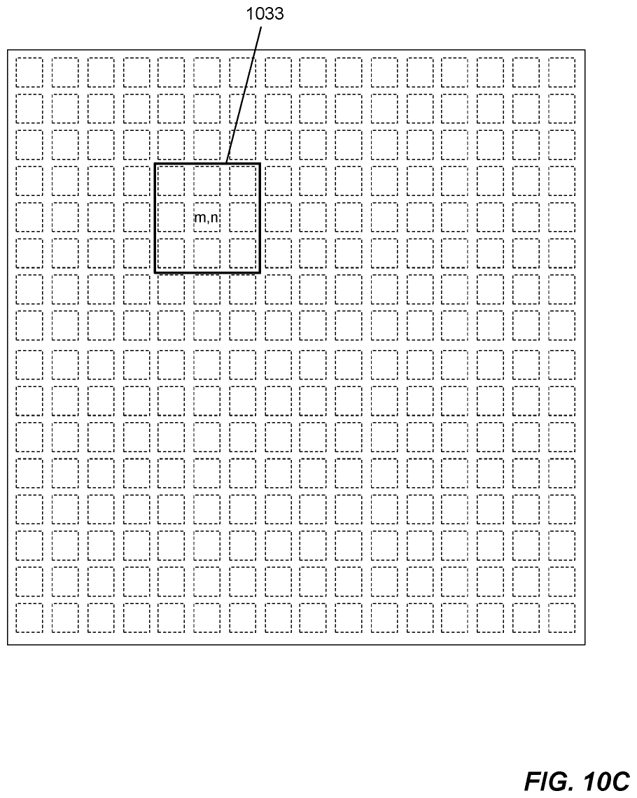

FIGS. 10A-10C show three different examples of the Z×Z pixel locations. The first pixel location 1031 shown in FIG. 10A is in the center of a 3-pixel by 3-pixel area within the (Z+2)-pixel by (Z+2)-pixel region at the upper left corner. The second pixel location 1032 shown in FIG. 10B is one pixel data shift to the right of the first pixel location 1031. The third pixel location 1033 shown in FIG. 10C is a typical example pixel location. Z×Z pixel locations contain multiple overlapping 3-pixel by 3-pixel areas within the (Z+2)-pixel by (Z+2)-pixel region.

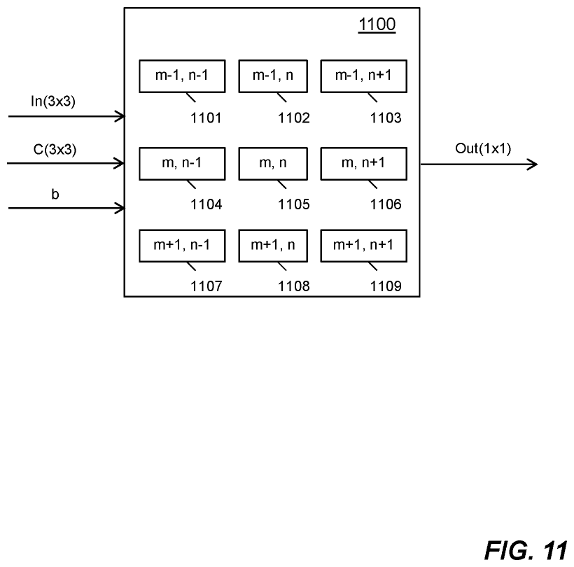

To perform 3×3 convolutions at each sampling location, an example data arrangement is shown in FIG. 11. Imagery data (i.e., In(3×3)) and filter coefficients (i.e., weight coefficients C(3×3) and an offset coefficient b) are fed into an example CNN 3×3 circuitry 1100. After 3×3 convolutions operation in accordance with Formula (1), one output result (i.e., Out(1×1)) is produced. At each sampling location, the imagery data In(3×3) is centered at pixel coordinates (m, n) 1105 with eight immediate neighbor pixels 1101-1104, 1106-1109.

Imagery data are stored in a first set of memory buffers 806, while filter coefficients are stored in a second set of memory buffers 808. Both imagery data and filter coefficients are fed to the CNN block 804 at each clock of the digital integrated circuit. Filter coefficients (i.e., C(3×3) and b) are fed into the CNN processing block 804 directly from the second set of memory buffers 808. However, imagery data are fed into the CNN processing block 804 via a multiplexer MUX 805 from the first set of memory buffers 806. Multiplexer 805 selects imagery data from the first set of memory buffers based on a clock signal (e.g., pulse 812).

Otherwise, multiplexer MUX 805 selects imagery data from a first neighbor CNN processing engine (from the left side of FIG. 8 not shown) through a clock-skew circuit 820.

At the same time, a copy of the imagery data fed into the CNN processing block 804 is sent to a second neighbor CNN processing engine (to the right side of FIG. 8 not shown) via the clock-skew circuit 820. Clock-skew circuit 820 can be achieved with known techniques (e.g., a D flip-flop 822).

After 3×3 convolutions for each group of imagery data are performed for predefined number of filter coefficients, convolution operations results Out(m, n) are sent to the first set of memory buffers via another multiplex MUX 807 based on another clock signal (e.g., pulse 811). An example clock cycle 810 is drawn for demonstrating the time relationship between pulse 811 and pulse 812. As shown pulse 811 is one clock before pulse 812, as a result, the 3×3 convolution operations results are stored into the first set of memory buffers after a particular block of imagery data has been processed by all CNN processing engines through the clock-skew circuit 820.

After the convolution operations result Out(m, n) is obtained from Formula (1), activation procedure may be performed. Any convolution operations result, Out(m, n), less than zero (i.e., negative value) is set to zero. In other words, only positive value of output results are kept. For example, positive output value 10.5 retains as 10.5 while −2.3 becomes 0. Activation causes non-linearity in the CNN based integrated circuits.

If a 2×2 pooling operation is required, the Z×Z output results are reduced to (Z/2)×(Z/2). In order to store the (Z/2)×(Z/2) output results in corresponding locations in the first set of memory buffers, additional bookkeeping techniques are required to track proper memory addresses such that four (Z/2)×(Z/2) output results can be processed in one CNN processing engine.

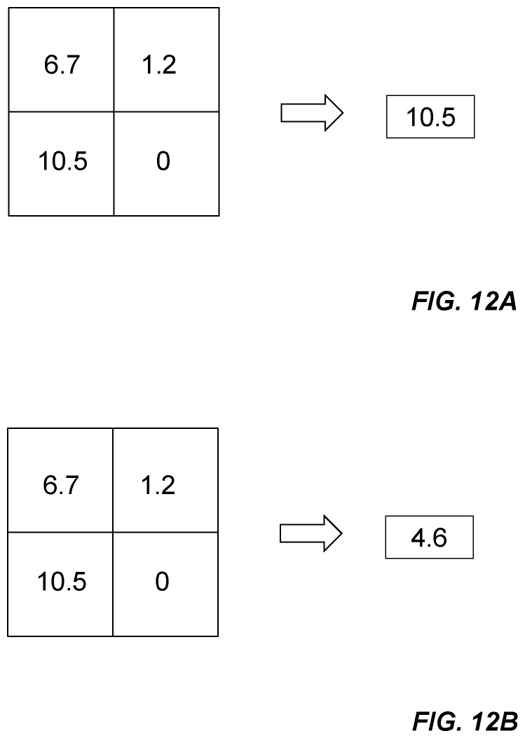

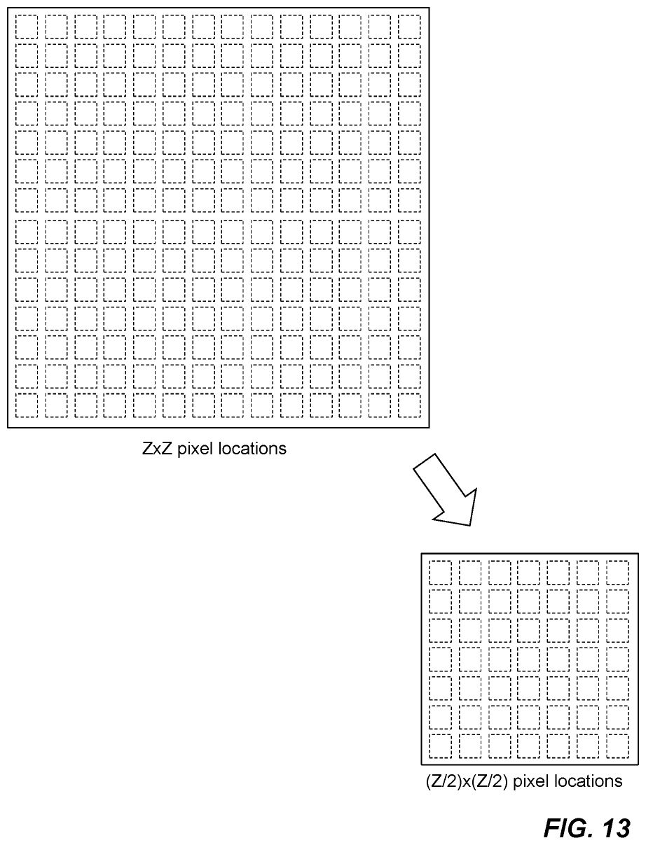

To demonstrate a 2×2 pooling operation, FIG. 12A is a diagram graphically showing first example output results of a 2-pixel by 2-pixel block being reduced to a single value 10.5, which is the largest value of the four output results. The technique shown in FIG. 12A is referred to as “max pooling”. When the average value 4.6 of the four output results is used for the single value shown in FIG. 12B, it is referred to as “average pooling”. There are other pooling operations, for example, “mixed max average pooling” which is a combination of “max pooling” and “average pooling”. The main goal of the pooling operation is to reduce size of the imagery data being processed. FIG. 13 is a diagram illustrating Z×Z pixel locations, through a 2×2 pooling operation, being reduced to (Z/2)×(Z/2) locations, which is one fourth of the original size.

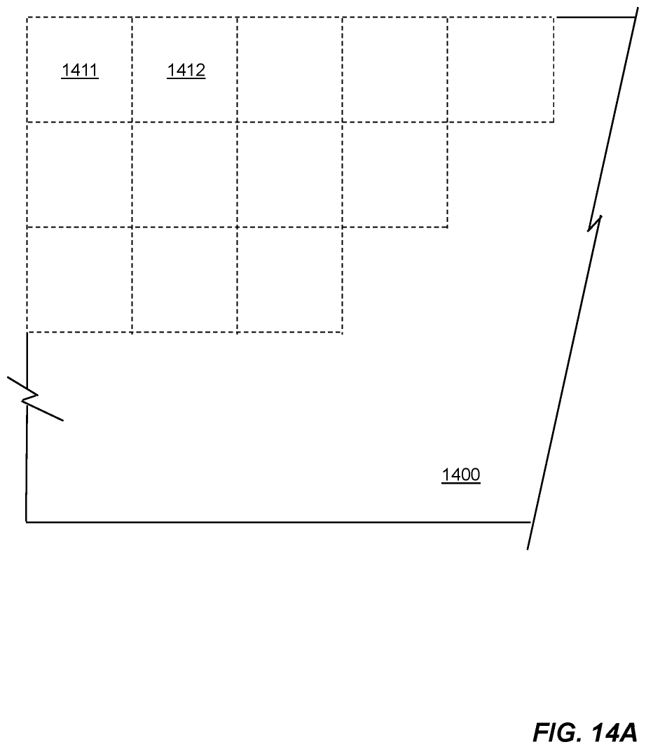

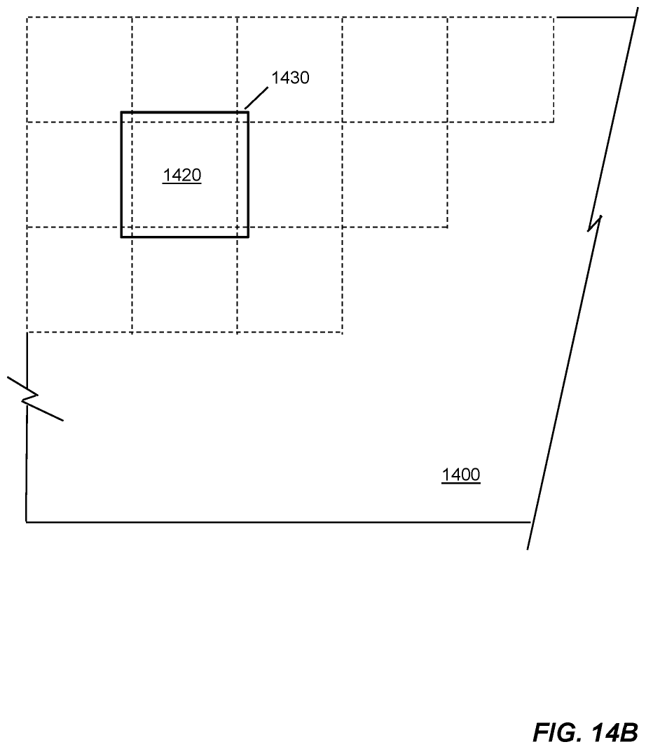

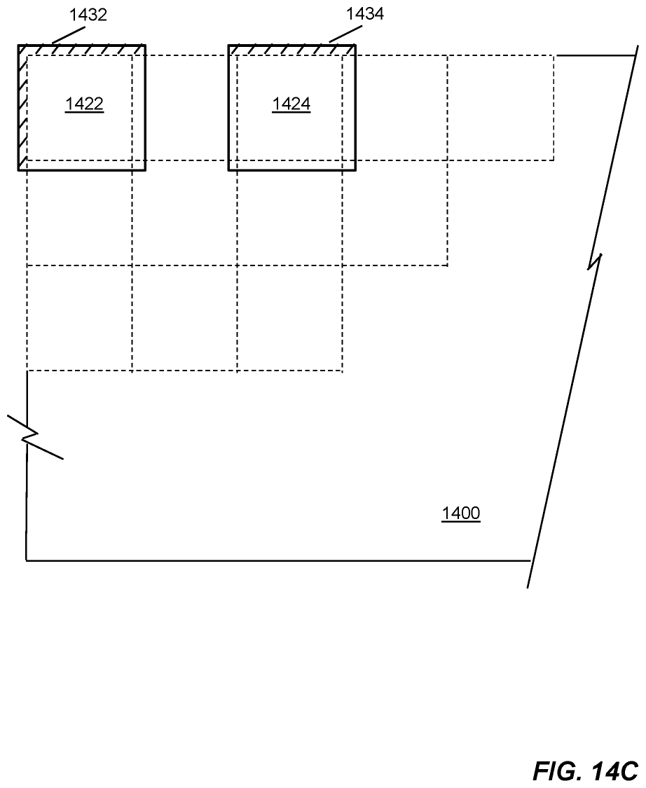

An input image generally contains a large amount of imagery data. In order to perform image processing operations, an example input image 1400 (e.g., a two-dimensional symbol 100 of FIG. 1) is partitioned into Z-pixel by Z-pixel blocks 1411-1412 as shown in FIG. 14A. Imagery data associated with each of these Z-pixel by Z-pixel blocks is then fed into respective CNN processing engines. At each of the Z×Z pixel locations in a particular Z-pixel by Z-pixel block, 3×3 convolutions are simultaneously performed in the corresponding CNN processing block.

Although the invention does not require specific characteristic dimension of an input image, the input image may be required to resize to fit into a predefined characteristic dimension for certain image processing procedures. In an embodiment, a square shape with (2^{L}×Z)-pixel by (2^{L}×Z)-pixel is required. L is a positive integer (e.g., 1, 2, 3, 4, etc.). When Z equals 14 and L equals 4, the characteristic dimension is 224. In another embodiment, the input image is a rectangular shape with dimensions of (2^{I}×Z)-pixel and (2^{J}×Z)-pixel, where I and J are positive integers.

In order to properly perform 3×3 convolutions at pixel locations around the border of a Z-pixel by Z-pixel block, additional imagery data from neighboring blocks are required. FIG. 14B shows a typical Z-pixel by Z-pixel block 1420 (bordered with dotted lines) within a (Z+2)-pixel by (Z+2)-pixel region 1430. The (Z+2)-pixel by (Z+2)-pixel region is formed by a central portion of Z-pixel by Z-pixel from the current block, and four edges (i.e., top, right, bottom and left) and four corners (i.e., top-left, top-right, bottom-right and bottom-left) from corresponding neighboring blocks.

FIG. 14C shows two example Z-pixel by Z-pixel blocks 1422-1424 and respective associated (Z+2)-pixel by (Z+2)-pixel regions 1432-1434. These two example blocks 1422-1424 are located along the perimeter of the input image. The first example Z-pixel by Z-pixel block 1422 is located at top-left corner, therefore, the first example block 1422 has neighbors for two edges and one corner. Value “0”s are used for the two edges and three corners without neighbors (shown as shaded area) in the associated (Z+2)-pixel by (Z+2)-pixel region 1432 for forming imagery data. Similarly, the associated (Z+2)-pixel by (Z+2)-pixel region 1434 of the second example block 1424 requires “0”s be used for the top edge and two top corners. Other blocks along the perimeter of the input image are treated similarly. In other words, for the purpose to perform 3×3 convolutions at each pixel of the input image, a layer of zeros (“0”s) is added outside of the perimeter of the input image. This can be achieved with many well-known techniques. For example, default values of the first set of memory buffers are set to zero. If no imagery data is filled in from the neighboring blocks, those edges and corners would contain zeros.

When more than one CNN processing engine is configured on the integrated circuit. The CNN processing engine is connected to first and second neighbor CNN processing engines via a clock-skew circuit. For illustration simplicity, only CNN processing block and memory buffers for imagery data are shown. An example clock-skew circuit 1540 for a group of example CNN processing engines are shown in FIG. 15.

CNN processing engines connected via the second example clock-skew circuit 1540 to form a loop. In other words, each CNN processing engine sends its own imagery data to a first neighbor and, at the same time, receives a second neighbor's imagery data. Clock-skew circuit 1540 can be achieved with well-known manners. For example, each CNN processing engine is connected with a D flip-flop 1542.

The first example artificial intelligence device for keywords detection 1600 is an embedded system using CNN based integrated circuit 1602 for computations of convolutional layers using pre-trained filter coefficients stored therein. Memory 1604 is configured for storing at least the received input string of texts. The processing unit 1612 controls input interface 1616 to receive input string of texts. Processing unit 1612 then forms a two-dimensional (2-D) symbol in accordance with a set of 2-D symbol creation rules using a 2-D symbol creation application module installed thereon.

The 2-D symbol is an imagery data that can be classified using a CNN based integrated circuit loaded with a deep learning model. The deep learning model contained at least multiple ordered convolutional layers, fully-connected layers, pooling operations and activation operations. Display device 1618 displays the input string of texts and later the determined category.

FIG. 17 shows a second example artificial intelligence device for keywords detection 1700, which contains a dongle 1701 and a host 1700 (e.g., a mobile phone) connected through a bus 1710 (e.g., USB—Universal Serial Bus).

Dongle 1701 contains a CNN based integrated circuit 1702 and a DRAM (Dynamic Random Access Memory) 1704. Host 1720 contains a processing unit 1722, memory 1724, input interface 1726 and display screen 1728. In one embodiment, when the host 1720 is a mobile phone, the input means 1726 can be through the display screen 1728 as touch screen input.

Although the invention has been described with reference to specific embodiments thereof, these embodiments are merely illustrative, and not restrictive of, the invention. Various modifications or changes to the specifically disclosed example embodiments will be suggested to persons skilled in the art. For example, whereas the two-dimensional symbol has been described and shown with a specific example of a matrix of 224×224 pixels, other sizes may be used for achieving substantially similar objectives of the invention, for example, 896×896. Additionally, whereas each 2-D symbol has been shown and described to contain 64 words, other number of words may be used for achieving the same, for example, 16, 256, or other number of words. Furthermore, whereas the example samples have been shown and described with two to three samples/records, in reality, multiple thousands or millions samples/records are required to properly train the deep learning model. Finally, whereas the length of the example sample has been shown and described with limited number of words for illustration clarity and simplicity, in reality, most of the samples may contain larger number of words to form a 2-D symbol (e.g., 64 words). In summary, the scope of the invention should not be restricted to the specific example embodiments disclosed herein, and all modifications that are readily suggested to those of ordinary skill in the art should be included within the spirit and purview of this application and scope of the appended claims.

1. An artificial intelligence device for keywords detection comprising:
a bus;
an input interface operatively connecting to the bus for receiving an input string of texts;
a processing unit operatively connecting to the bus for forming a two-dimensional (2-D) symbol using a 2-D symbol creation application module installed thereon, the 2-D symbol being a matrix of N×N pixels of data for containing the input string of texts, where N is a positive integer; and
operatively connecting to the bus, a Cellular Neural Networks or Cellular Nonlinear Networks (CNN) based integrated circuit loaded with a deep learning model for detecting whether the input string of texts contains one of a list of keywords in a category of interest, filter coefficients of a plurality of ordered convolutional layers in the deep learning model being trained using a keyword detection training dataset with an image classification technique.

2. The artificial intelligence device for keywords detection of claim 1, wherein
the keyword detection training dataset is created by following operations:
defining and receiving the list of keywords from a user of the artificial intelligence device for keywords detection;
optionally modifying the list of keywords by adding one or more items for increasing robustness during training of a deep learning model for keywords detection;
deriving a list of to-be-excluded items from the list of keywords for avoiding false alarms or confusions during training of the deep learning model;
gathering a first set of general texts of various topics unrelated to the category of interest;
expanding each sample or record of the first set to include all possible shorter samples;
creating a second set of texts by inserting or replacing a randomly selected item from the list of keywords into each of the first set at a randomly chosen location within said each of the first set;
forming a first group of two-dimensional (2-D) symbols to graphically represent the second set and the first group of 2-D symbols being associated with the category of interest;
creating a third set of texts by inserting or replacing a randomly selected item from the list of to-be-excluded into each of the first set at a randomly chosen location within said each of the first set;
forming a second group of 2-D symbols to graphically represent the third set and the second group of 2-D symbols being assigned with a category of uninterested; and
creating the keyword detection training dataset by combining the first group and the second group of the 2-D symbols.

3. The artificial intelligence device for keywords detection of claim 2, wherein said forming the first group of 2-D symbols is based on a squared word format.

4. The artificial intelligence device for keywords detection of claim 3, wherein the squared word format converts each word in Latin-alphabet based languages to a square format based on number of alphabet in said each word.

5. The artificial intelligence device for keywords detection of claim 2, said forming the second group of 2-D symbols is based on a squared word format.

6. The artificial intelligence device for keywords detection of claim 5, wherein the squared word format converts each word in Latin-alphabet based languages to a square format based on number of alphabet in said each word.

7. The artificial intelligence device for keywords detection of claim 1, further comprises a display unit operatively connecting to the bus.

8. The artificial intelligence device for keywords detection of claim 1, wherein the CNN based integrated circuit comprises a plurality of CNN processing engines operatively coupled to at least one input/output data bus, the plurality of CNN processing engines being connected in a loop with a clock-skew circuit, each CNN processing engine comprising:
a CNN processing block configured for simultaneously performing convolutional operations of the 2-D symbol and the filter coefficients of a plurality of ordered convolutional layers of the deep learning model;
a first set of memory buffers operatively coupling to the CNN processing block for storing the 2-D symbol; and
a second set of memory buffers operatively coupling to the CNN processing block for storing the filter coefficients.

9. The artificial intelligence device for keywords detection of claim 8, wherein the CNN based integrated circuit further performs pooling operations and activation operations.

10. The artificial intelligence device for keywords detection of claim 1, further comprises a memory operatively connected to the bus for providing data storage for the processing unit.

11. A method implemented in a computing system for enabling an artificial intelligence device for keywords detection comprising:
receiving a list of keywords in a category of interest;
optionally modifying the list of keywords by adding one or more items for increasing robustness during training of a deep learning model for keywords detection;
deriving a list of to-be-excluded items from the list of keywords for avoiding false alarms or confusions during training of the deep learning model;
gathering a first set of general texts of various topics unrelated to the category of interest;
expanding each sample or record of the first set to include all possible shorter samples;
creating a second set of texts by inserting or replacing a randomly selected item from the list of keywords into each of the first set at a randomly chosen location within said each of the first set;
forming a first group of two-dimensional (2-D) symbols to graphically represent the second set and the first group of 2-D symbols being associated with the category of interest;
creating a third set of texts by inserting or replacing a randomly selected item from the list of to-be-excluded into each of the first set at a randomly chosen location within said each of the first set;
forming a second group of 2-D symbols to graphically represent the third set and the second group of 2-D symbols being assigned with a category of uninterested; and
creating a keyword detection training dataset by combining the first group and the second group of the 2-D symbols.

12. The method of claim 11, wherein said forming the first group of 2-D symbols is based on a squared word format.

13. The method of claim 12, wherein the squared word format converts each word in Latin-alphabet based languages to a square format based on number of alphabet in said each word.

14. The method of claim 11, said forming the second group of 2-D symbols is based on a squared word format.

15. The method of claim 14, wherein the squared word format converts each word in Latin-alphabet based languages to a square format based on number of alphabet in said each word.

16. The method of claim 11, wherein the first set of general texts are gathered from a publicly available source.

17. The method of claim 11, wherein each of the first set of general texts includes a plurality of natural language words.

18. The method of claim 17, wherein the plurality of natural language words contains more than one natural languages.

19. The method of claim 11, wherein the image classification technique comprises a binary classification that contains the category of interest and the category of uninterested.
